(19) United States
(12) Patent Application Publication
(10) Pub. No.: US 2011/0032399 A1
(43) Pub. Date: Feb. 10, 2011

(54) DOUBLE-LIGHT SOURCES OPTICAL SCANNING DEVICE AND METHOD OF USING THE SAME

(76) Inventors: Wei-Chao Kao, Hsi Chih (TW); Tai-Hsing Wang, Hsi Chih (TW); Chun-Hsiao Lee, Hsi Chih (TW)

Correspondence Address: Muncy, Geissler, Olds & Lowe, PLLC, 4000 Legato Road, Suite 310, FAIRFAX, VA, 22033, US

(21) Appl. No.: 12/555,474

(22) Filed: Sep. 8, 2009

(30) Foreign Application Priority Data
Aug. 4, 2009 (TW) 098126278

(51) Int. Cl. H04N 5/335; H04N 5/225

(52) U.S. Cl. 348/294; 348/207.99; 348/E05.091

(57) ABSTRACT

A double-light sources optical scanning device and method of using the same is disclosed. The double-light sources optical scanning device comprises: a light-source backlight module, an optical lens, and an area optical sensing device. The light-source backlight module comprising a white light source and an infrared light source, irradiating at least an object for scanning to generate an image. The optical lens projects the image to the area optical sensing device and divides the image generated by the white light source and the infrared light source. Turning on the white light source or the infrared light source through a switching control circuit, wherein determining where the contaminative positions are placed on the object by irradiating with infrared, and cleaning and repairing contaminations and damages shown in the image generated by the white light source.

### BACKGROUND OF THE INVENTION

1. Field of the Invention

The present invention relates to an optical scanning device, and in particular to an optical scanning device having a white light source and an infrared light source to determine damage and contaminations of an object-to-be-scanned and method of using the same.

2. Description of the Related Art

In general, a conventional camera utilizes photosensitive films as negatives, however, the film negative is not easy to preserve, since images thereon will deteriorate along with the time or even disappear, thus it can not be used to produce the original images thereon, in addition, it is rather difficult to restore the images on the conventional negatives, and this could cause disappointment and inconvenience to the users.

Along with the progress of digital technology and market demand, such that in addition to being capable of scanning documents and drawings, in order to fulfill the negative scanning functions, a backlight source is further provided, so that images on photographs and negatives can be converted into digital data through utilizing a special dedicated scanning device, and then the digital data are stored in a computer. But the photographs and negatives have contaminations or scars, the digital data shows the contaminations or scars. The scanner scanning contaminations and damages of positives, negatives or photographs comprises a plurality of white-light light-emitting-diodes and infrared light sources. Because the white-light light-emitting-diodes and infrared light sources are different light-source backlight modules, the two different light-source backlight modules is required to assemble a component module, so as to detect a position of contaminations and damages by infrared. The infrared-detecting technique needs high cost. Besides, infrared is emitted by cold cathode rays, and the cold cathode rays requiring the preheating time and having short service life can influence the service life of the scanner.

In view of the problems and shortcomings of the prior art, the present invention discloses a double-light sources optical scanning device and method of using the same, so as to overcome the problems of the prior art.

### SUMMARY OF THE INVENTION

A major objective of the present invention is to provide a double-light sources optical scanning device and method of using the same, that a light-source backlight module comprising a white light (namely, visible light) source and an infrared light source, scanning a negative, a positive, and a photograph of an object for scanning, finding contaminations and scars of the object by the optical refraction theorem and cleaning them to repair a digital image of the object.

Another objective of the present invention is to provide a double-light sources optical scanning device and method of using the same, wherein, a white light source and an infrared light source are light-emitting-diodes (LEDs) and have lower cost and longer service life than the infrared light source of cold cathode rays. Besides, the white light source and the infrared light source of the present invention don't need preheating time.

To achieve the abovementioned objectives, the present invention provides a double-light sources optical scanning device, which comprises a light-source backlight module, including a white light source and an infrared light source, used to irradiate at least one object for scanning; an optical lens, used to project an image generated by the object reflecting light emitted by the light-source backlight module; an area optical sensing device, receiving the image projected by said optical lens, generating an image signal corresponding the image; a switching control circuit, turning on the white light source or the infrared light source of the light-source backlight module; and an image processing module, which compares the scanned image generated by the object reflecting light emitted by the white light source and the infrared light source, then repairs contaminations and damages shown in the image. Moreover, the area optical sensing device is an area charge-coupled device (Area CCD) or area complementary metal-oxide-semiconductor (Area CMOS).

Moreover, the present invention provides a double-light sources optical scanning method, including the following steps: turning on a first light source of a light-source backlight module through a switching control circuit; the first light source irradiating an object for scanning to generate a first light source image, and projecting the first light source image to an area optical sensing device; switching to turn on a second light source of the light-source backlight module through the switching control circuit; the second light source irradiating the object to generate a second light source image, and projecting the second light source image to the area optical sensing device; determining that the first light source image and the second light source image show contaminations and damages by an image process module, repairing the contaminations and damages on the first light source image and the second light source image. Besides, the first light source and the second light source are respectively a white light source or an infrared light source. No matter the white light source or the infrared light source is turned on, the scanned images show a contaminations and damages on the same position, and the two images of the white light source and the infrared light source are repaired in the image processing module.

Below, the embodiments are described in detail in cooperation with the drawings to make easily understood the technical contents, characteristics and efficacies of the present invention.

### BRIEF DESCRIPTION OF THE DRAWINGS

FIG. 1 is a schematic diagram of a double-light sources optical scanning device according to an embodiment of the present invention; and

FIG. 2 is a flowchart of the steps of the double-light sources optical scanning method according to an embodiment of the present invention.

### DETAILED DESCRIPTION OF THE INVENTION

The present invention provides a double-light sources optical scanning device and method of using the same. The optical scanning device comprising white light source and infrared light source, switching the two kind of light sources by using refraction theorem of light to achieve the purpose of detecting a contaminative position of the object-to-be-scanned by infrared.

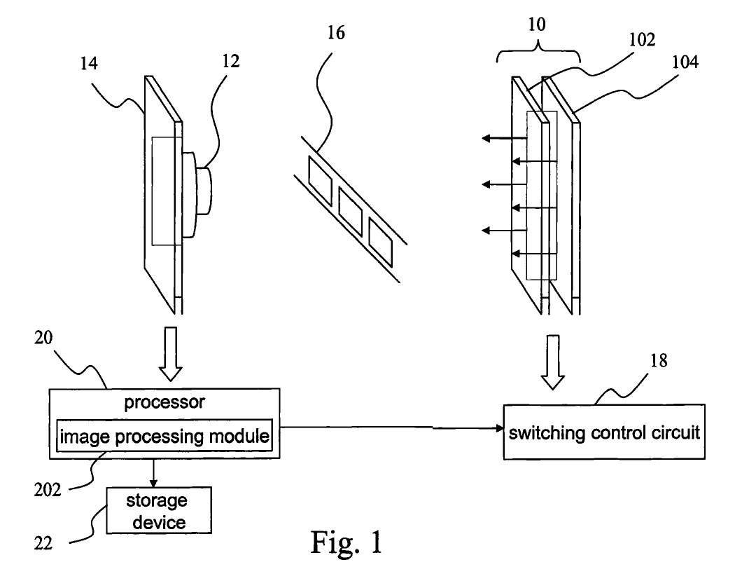

As shown in FIG. 1, the double-light sources optical scanning device comprises: a light-source backlight module 10, an optical lens 12, an area optical sensing device 14, a switching control circuit 18, and a processor 20. The light-source backlight module 10 comprises a white light source 102 and an infrared light source 104, wherein the white light source 102 and the infrared light source 104 are respectively a white-light light-emitting-diode (LED) and an infrared LED. The optical lens 12 is placed between the light-source backlight module 10 and the area optical sensing device 14, and an object for scanning is placed between the light-source backlight module 10 and optical lens 12. The object is a negative, a positive or a photograph, and the area optical sensing device is an area charge-coupled device (Area CCD) or area complementary metal-oxide-semiconductor (Area CMOS). An image is generated by the object 16 reflecting light emitted by the light-source backlight module 10, wherein the image generated by the object 16 reflecting light emitted by the white light source 102 shows a physical picture of the object, and the image generated by the object 16 reflecting light emitted by the infrared light source 104 shows contaminations and scars of the object. The optical lens 12 is used to project the image generated by the object 16 reflecting light emitted by the light-source backlight module 10 to the area optical sensing device 14, and then the area optical sensing device 14 generates a corresponding image signal.

The switching control circuit 18 is used to turn on the white light source 102 or the infrared light source 104, and the processor 20 sends out a control signal to the switching control circuit 18, as such that the switching control circuit 18 turns on the white light source 102 or the infrared light source 104 of the light-source backlight module 10. The processor 20 further comprises an image processing module 202, which receives the image signal generated by the area optical sensing device 14 and process the image signal, so as to determine that the object 16 has contaminations and damages, then the image processing module 202 repairs the contaminations and damages of the object 16 through utilizing an image processing software.

The double-light sources optical scanning device further comprises a storage device 22, stores the image signal transmitted by the area optical sensing device 14 and the image generated by the object 16 reflecting light emitted by the white light source 102 and the infrared light source 104.

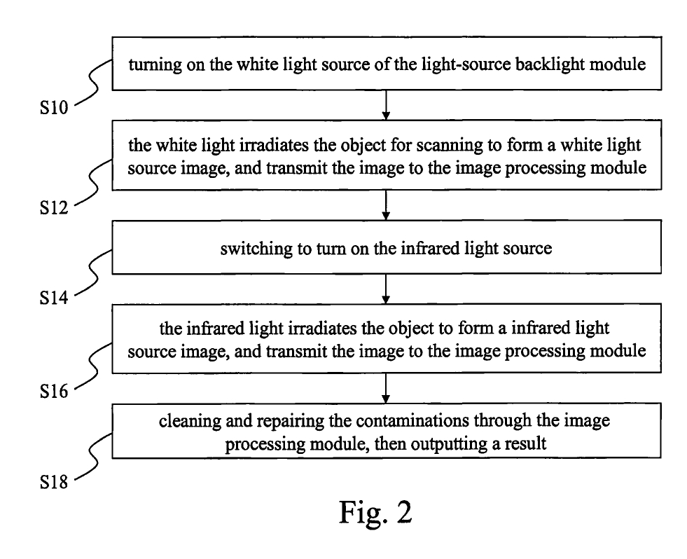

Refer to FIG. 2 for a flowchart of the steps of the double-light sources optical scanning method according to an embodiment of the present invention. Wherein, in Step S10, the processor sends out a control signal to the switching control circuit, as such the switching control circuit turns the white light source of the light-source backlight module, next, in Step S12, the optical lens projects the image generated by the object reflecting light emitted by the white light source to the area optical sensing device, and the area optical sensing device sends out an image signal of the white light source to the image processing module, then as shown in Step S14, the processor sends out an another control signal to the switching control circuit, as such the switching control circuit switches to turn the infrared light source of the light-source backlight module, then as shown in Step S16, the optical lens projects the image generated by the object reflecting light emitted by the infrared light source to the area optical sensing device, and the area optical sensing device sends out an image signal of the infrared light source to the image processing module, then as shown in Step S18, obtaining a position of contaminations and damages on the image of the white light source and cleaning contaminations and damages shown in said same position on the image of the infrared light source by the image process module, then a repairing process is completed and the final result is obtained.

In this flowchart, the starting sequence for the white light source and the infrared light source can be reverse. In other words, turning on the infrared light source for the scanning process, and then switching to turn on the white light source for the scanning process. No matter the white light source or the infrared light source is turned on, the two images of the white light source and the infrared light source are repaired in the image processing module.

An image generated by the object reflecting light emitted by the white light source shows physical picture of the object and comprises appearance of the image and the contaminations and damages, but an image generated by the object reflecting light emitted by the infrared light source only shows the contaminations and damages of the object. Thus, obtaining a position of contaminations and damages on the image of the white light source and cleaning contaminations and damages shown in said same position on the image of the infrared light source, and then the image process is completed.

Summing up the above, the light-source backlight module of the present invention comprising the white light source and infrared light source, finding and cleaning the contaminations and scars of the object by the optical refraction theorem to repair the digital image of the object. Because the cost of the LED used as a light source is lower, and a same light-source backlight module comprises the two light sources, which is controlled by the switching control circuit. Besides, the two light sources don't require other component modules to assemble. The double-light sources optical scanning device of the present invention can't only reduce the fabrication cost, but also have better efficiency to scan with infrared.

The embodiments described above are only to exemplify the present invention but not to limit the scope of the present invention. Therefore, any equivalent modification or variation according to the spirit of the present invention is to be also included within the scope of the present invention.

What is claimed is:

1. A double-light sources optical scanning device, comprising:
a light-source backlight module, including a white light source and an infrared light source, used to irradiate at least one object for scanning;
an optical lens, used to project an image generated by said object reflecting light emitted by said light-source backlight module;
an area optical sensing device, receiving said image projected by said optical lens, generating an image signal corresponding said image; and
a switching control circuit, turning on said white light source or said infrared light source of said light-source backlight module.

2. The double-light sources optical scanning device as claimed in claim 1, wherein said image generated by said object reflecting light of said infrared light source shows contaminations and damages of said object.

3. The double-light sources optical scanning device as claimed in claim 1, wherein said object is a negative, a positive or a photograph.

4. The double-light sources optical scanning device as claimed in claim 1, wherein said area optical sensing device paralleled said light-source backlight module.

5. The double-light sources optical scanning device as claimed in claim 1, wherein said white light source comprises at least one white-light light-emitting-diode (LED).

6. The double-light sources optical scanning device as claimed in claim 1, wherein said infrared light source comprises at least one infrared light-emitting-diode.

7. The double-light sources optical scanning device as claimed in claim 1, wherein said white light source, said infrared light source and said object are paralleled, and said white light source is close to said object.

8. The double-light sources optical scanning device as claimed in claim 1, further comprising a processor to control said switching control circuit.

9. The double-light sources optical scanning device as claimed in claim 8, wherein said processor further comprises an image processing module, which processes said image signal to determine a contaminative position of said object, then repairs contaminations and damages of said object.

10. The double-light sources optical scanning device as claimed in claim 1, further comprising a storage device to store said image signal and said image.

11. The double-light sources optical scanning device as claimed in claim 1, wherein said area optical sensing device is an area charge-coupled device (Area CCD) or an area complementary metal-oxide-semiconductor (Area CMOS).

12. A double-light sources optical scanning method, comprising the following steps:
turning on a first light source of a light-source backlight module through a switching control circuit;
said first light source irradiating an object for scanning to generate a first light source image, and projecting said first light source image to an area optical sensing device;
switching to turn on a second light source of said light-source backlight module through said switching control circuit;
said second light source irradiating said object to generate a second light source image, and projecting said second light source image to said area optical sensing device;
determining whether there are contaminations and damages on said first light source image and said second light source image or not by an image process module, and repairing said contaminations and damages on said first light source image and said second light source image.

13. The double-light sources optical scanning device as claimed in claim 12, wherein said first light source is a white light source or an infrared light source.

14. The double-light sources optical scanning device as claimed in claim 12, wherein said second light source is an infrared light source or a white light source.

15. The double-light sources optical scanning device as claimed in claim 12, wherein said first light source image and said second light source image are projected to said area optical sensing device through a optical lens.

16. The double-light sources optical scanning method as claimed in claim 12, wherein said object is a negative, a positive or a photograph.

17. The double-light sources optical scanning method as claimed in claim 12, wherein said first light source and said second light source are light-emitting-diodes.

18. The double-light sources optical scanning method as claimed in claim 12, wherein when said first light source and said second light source are respectively white light source and infrared light source, said first light source image shows an image and contaminations and damages of said object and said second light source image shows contaminations and damages of said object, obtaining a position of contaminations and damages on said second light source image and cleaning contaminations and damages shown in said same position on said first light source image by an image process module, then a repairing process is completed.

19. The double-light sources optical scanning method as claimed in claim 12, wherein said image process module is located in a processor controlling said switching control circuit.
